(19) United States
(12) Patent Application Publication
(10) Pub. No.: US 2015/0221022 A1
(43) Pub. Date: Aug. 6, 2015

(54) SYSTEMS AND METHODS FOR MOBILE INTEGRATED ORDERING

(71) Applicant: Sears Brands, L.L.C., Hoffman Estates, IL (US)

(72) Inventors: Xiaoyuan Gu, Chicago, IL (US); Vinod Ekambaram, Schaumburg, IL (US); Abhishek Ramani, St. Charles, IL (US); Jen-Hao Yang, Schaumburg, IL (US)

(21) Appl. No.: 14/687,405

(22) Filed: Apr. 15, 2015

Related U.S. Application Data
(63) Continuation of application No. 13/711,960, filed on Dec. 12, 2012.
(60) Provisional application No. 61/569,580, filed on Dec. 12, 2011.

(51) Int. Cl. G06Q 30/06

(52) U.S. Cl. CPC G06Q 30/0635

(57) ABSTRACT

Methods and apparatus are disclosed regarding an e-commerce environment with integrated mobile ordering capabilities. One method includes receiving, from a mobile computing device, an order for at least one item, detecting a location of the mobile computing device, and requesting deliver of the at least one item to the detected location.

### CROSS-REFERENCE TO RELATED APPLICATIONS/INCORPORATION BY REFERENCE

This application is a continuation of U.S. patent application Ser. No. 13/711,960, filed Dec. 12, 2012, which claims the benefit of U.S. Provisional Application No. 61/569,580, entitled “SYSTEMS AND METHODS FOR MOBILE INTEGRATED ORDERING” which was filed Dec. 12, 2011, the disclosures of which are expressly hereby incorporated by reference herein in their entirety.

### FIELD OF THE INVENTION

The present description relates generally to mobile food, item, and/or service ordering, and more particularly to systems and methods for mobile integrated ordering.

### BACKGROUND OF THE INVENTION

The financial success of many businesses hinges upon how efficiently customers are served. Customers commonly visit establishments such as retail stores, restaurants, service centers, etc. in order to purchase goods, food, and/or services. When visiting such establishments, customers often wait for employees to help them with their purchase of goods and/or services. From the customer's perspective, an employee would be available for immediate service. To achieve such an ideal, an establishment would need to maintain a large workforce to ensure an employee is available to handle customer needs on a moments notice. From the establishment's perspective, however, such a large workforce is costly and inefficient since many employees would remain idle for substantial periods. Thus, establishments generally staff to maintain a reasonable balance between periods of employee idleness and customer wait time. However, by employing techniques that more efficiently service customers, an establishment may improve a customer's perception of the provided level of service while maintaining a workforce with few periods of employee idleness.

Limitations and disadvantages of conventional and traditional approaches should become apparent to one of skill in the art, through comparison of such systems with aspects of the present invention as set forth in the remainder of the present application.

### BRIEF SUMMARY OF THE INVENTION

Apparatus and methods of integrating mobile ordering capabilities into an e-commerce environment are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows an e-commerce environment that supports ordering items from an establishment using a mobile computing device in accordance with an embodiment of the present invention.

FIG. 2 shows a simplified depiction of a computing device for use in the e-commerce environment of FIG. 1.

FIG. 3 shows a method for ordering items from an establishment in accordance with the e-commerce environment shown in FIG. 1.

### DETAILED DESCRIPTION OF THE INVENTION

Aspects of the present invention are related to mobile food, item, and/or service ordering. More specifically, certain embodiments of the present invention relate to systems and methods for mobile integrated ordering from establishments such as retail stores, restaurants, and service centers.

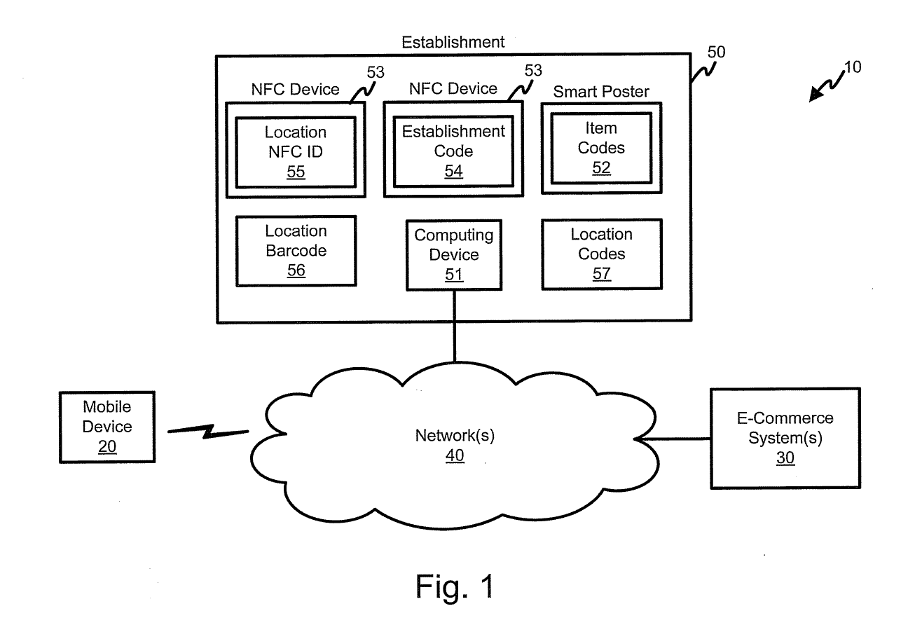

With today's technology, convenience, speed, and ease of use are typical features paramount to a successful e-commerce environment. As explained below, an e-commerce environment may support mobile and/or desktop applications that allow a user to quickly, conveniently and efficiently order and receive a food item and/or other items. To this end, an e-commerce environment 10 with integrated mobile ordering capabilities is depicted in FIG. 1.

As shown, the e-commerce environment 10 may include a mobile computing device 20 connected to one or more e-commerce systems 30 via one or more networks 40. The networks 40 may include a number of private and/or public networks such as, for example, wireless and/or wired LAN networks, cellular networks, and the Internet that collectively provide a communication path and/or paths between the mobile computing devices 20 and the one or more e-commerce systems 30. The mobile computing devices 20 may include laptops, tablets, smart phones, and/or some other types of mobile computing devices which enable a user to communicate with the e-commerce systems 30 via the network 40.

The e-commerce systems 30 may include one or more web servers, database servers, routers, load balancers, and/or other computing and/or networking devices. As explained in greater detail below, the e-commerce systems 30 may operate to provide an e-commerce experience that permits users of mobile client computing devices to order items such as goods and/or services from an establishment 50.

As shown, the establishment 50 may include a computing device 51 such as a workstation, desktop, laptop, or other computing device which is coupled to the network 40 in order to communicate with e-commerce systems 30. The establishment 50 may further include a smart poster 51 that presents item codes 52 for associated items offered by the establishment 50. The establishment 50 may further include one or more near field communication (NFC) devices or tags 53 configured to provide associated NFC identifiers (IDs) to mobile computing devices 20 that are placed proximate to such NFC devices 53. As depicted, the NFC devices 53 may provide NFC identifiers associated with an establishment code 54 or location code 55. The establishment 50 may further include locations codes such as NFC IDS 55, barcodes 56, and/or other scannable codes 57 positioned at various predetermined locations throughout the establishment 50.

Those skilled in the art readily appreciate that FIG. 1 depicts a simplified embodiment of the e-commerce environment 10 and that the e-commerce environment 10 may be implemented in numerous different manners using a wide range of different computing devices, platforms, networks, etc. Moreover, those skilled in the art readily appreciate that while aspects of the e-commerce environment 10 may be implemented using a client/server architecture, aspects of the e-commerce may be implemented using a peer to peer architecture or another networking architecture.

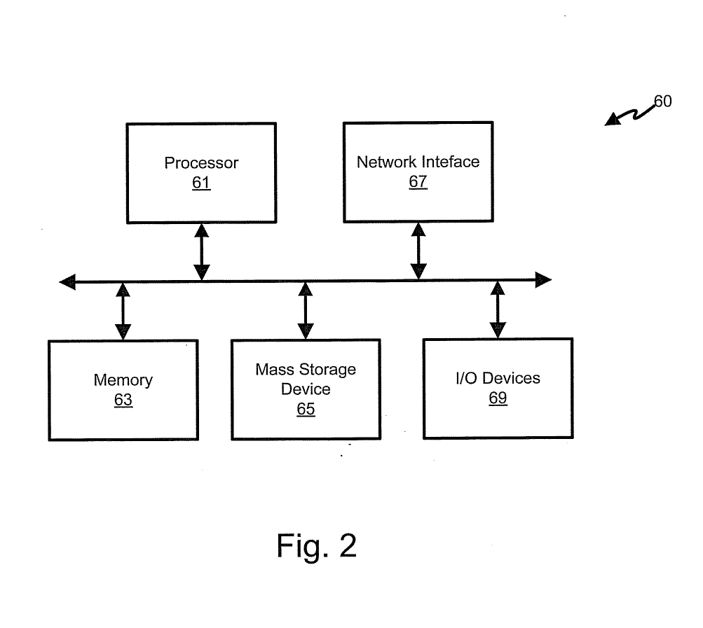

As noted above, the mobile computing device 20, computing device 51, and the e-commerce system 30 may be implemented using various types of computing devices. FIG. 2 provides a simplified depiction of a computing device 60 suitable for implementing the mobile computing device, the computing device 51, and/or aspects of the e-commerce system 30. As shown, the computing device 60 may include a processor 61, a memory 63, a mass storage device 65, a network interface 67, and various input/output (I/O) devices 69. The processor 61 may be configured to execute instructions, manipulate data and generally control operation of other components of the computing device 60 as a result of its execution. To this end, the processor 61 may include a general purpose processor such as an x86 processor or an ARM processor which are available from various vendors. However, the processor 61 may also be implemented using an application specific processor and/or other circuitry.

The memory 63 may store instructions and/or data to be executed and/or otherwise accessed by the processor 61. In some embodiments, the memory 63 may be completely and/or partially integrated with the processor 61.

In general, the mass storage device 65 may store software and/or firmware instructions which may be loaded in memory 63 and executed by processor 61. The mass storage device 65 may further store various types of data which the processor 61 may access, modify, and/otherwise manipulate in response to executing instructions from memory 63. To this end, the mass storage device 65 may comprise one or more redundant array of independent disks (RAID) devices, traditional hard disk drives (HDD), sold state device (SSD) drives, flash memory devices, read only memory (ROM) devices, etc.

The network interface 67 may enable the computing device 60 to communicate with other computing devices via network 40. To this end, the networking interface 67 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc) or near field communication (NFC) interface, and/or some other type of networking interface capable of providing a communications link between the computing device 60 and network 40 and/or another computing device.

Finally, the I/O devices 69 may generally provide devices which enable a user to interact with the computing device 60 by either receiving information from the computing device 60 and/or providing information to the computing device 60. For example, the I/O devices 69 may include display screens, keyboards, mice, touch screens, microphones, audio speakers, digital cameras, optical scanners, etc.

While the above provides some general aspects of a computing device 60, those skilled in the art readily appreciate that there may be significant variation in actual implementations of a computing device. For example, a smart phone implementation of a computing device generally uses different components and may have a different architecture than a database server implementation of a computing device. However, despite such differences, computing devices still generally include processors that execute software and/or firmware instructions in order to implement various functionality. As such, the above described aspects of the computing device 60 are not presented from a limiting standpoint but from a generally illustrative standpoint. The present application envisions that aspects of the present application will find utility across a vast array of different computing devices and the intention is not to limit the scope of the present application to a specific computing device and/or computing platform beyond any such limits that may be found in the appended claims.

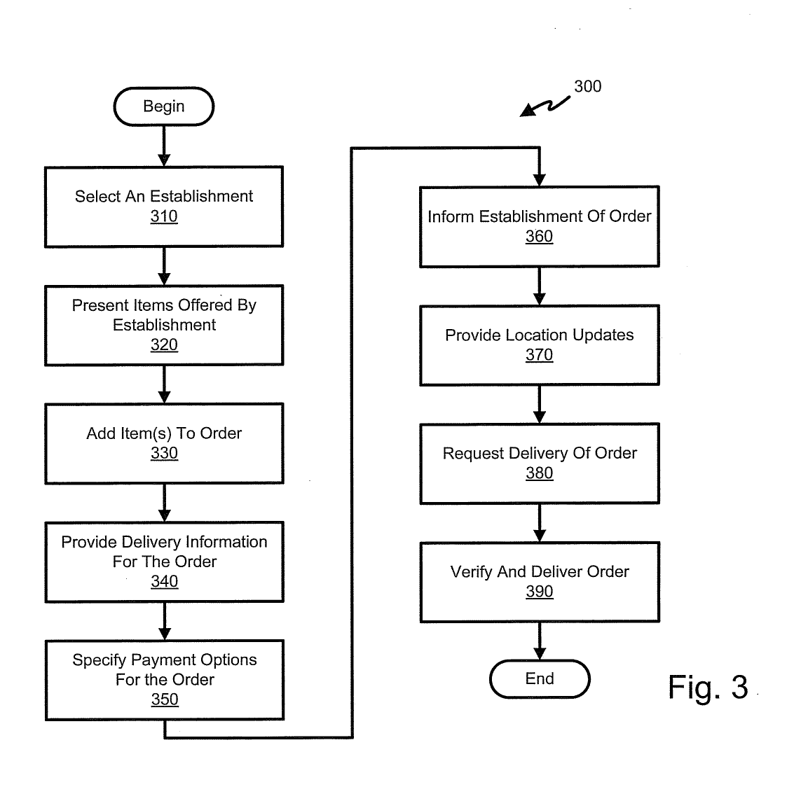

Referring now to FIG. 3, a method 300 of ordering items such as goods and/or services is depicted. As shown, a user at block 310 may select an establishment 50 and be presented with a list of items offered by the selected establishment 50. In one embodiment, the user may use their mobile computing device 20 to select a particular establishment 50 by scanning a unique identifier such as a two-dimensional barcode such as QR Code, barcode, or similar code or by activating a NFC tag or RFID tag. Such unique identifier may be presented at an establishment 50, a smart poster 51, in a flyer, in a print catalog, and/or via some other physical of virtual representation. In another embodiment, the mobile computing device 20 may provide a webpage and/or mobile application for a predetermined establishment or establishments 50.

For example, the mobile computing device 20 may provide a mobile application dedicated to a particular restaurant or other establishment and the user may select the establishment 50 by merely launching the appropriate application of the mobile computing device 20. Moreover, the mobile computing device 20 may provide a mobile application that supports placing orders with several establishments 50 and that permits the user to select an establishment from a predetermined list of supported establishments 50. In such instances, the mobile computing device 20 may present the user with at least one predetermined establishment 50 and/or a menu of establishments 50 that are a dynamic generated based upon a downloaded and/or otherwise determined scheme.

After selecting the establishment 50, the mobile computing device 20 at block 320 may present the user with a list of items offered by the selected establishment 50. For example, if the selected establishment 50 is a restaurant, the mobile computing device 20 may present the user with a menu of food items. Alternatively and/or in addition to presenting items via the mobile computing device 20, some embodiments may present items offered by the establishment 50 via an online website, at a kiosk, at a retail store, in a flyer, in print catalog, and/or via other physical or virtual representations of an establishment 50.

At block 330, the user may add one or more items to an order and send the order to an e-commerce system 30 for processing. In particular, a user may add an item such as a food item to an order through an online menu presented by mobile computing device 20, or through scanning codes provided by a smart poster 51 posted on a wall of an establishment 50.

Furthermore, the user at block 340 may provide the e-commerce system 30 delivery information for the ordered items. For example, the user may request the items be delivered to their seat or table, schedule a time for pick-up/delivery, and/or provide an estimated arrival time, e.g., a time they will be in the area.

At block 350, the user via the mobile computing device 20 may specify payment options. For example, the user via the mobile computing device 20 may prepay for the items through an electronic payment system. The user via the mobile computing device 20 may also specify that the items be paid at the time of receipt.

The e-commerce system 30 at block 360 may provide the establishment 50 with details regarding the order so that the establishment 50 may process the order. In particular, the e-commerce system 30 may send to the computing device 51 of the establishment 50 order details such as items ordered, contact information of the purchaser, expected delivery day and/or time, etc. In this way, the establishment 50 may prepare the order to ensure the order is ready at the requested time.

In order to facilitate delivery, the user at block 370 may provide updates regarding their location and/or the delivery location. For example, in one example, the user may make their order remotely from the establishment 50 and proceed to the establishment 50 for pick-up. After arriving at the establishment 50, the user may identify their location to the establishment 50 by using the mobile computing device 20 to activate NFC devices 53 or to scan barcodes 56 and/or other location codes 57. For example, in a restaurant establishment, the user may place their mobile computing device (e.g. smart phone) sufficiently proximate to an NFC device 53 of a particular table in order to provide an e-commerce system 30 for the establishment 50 with information regarding the user's location. The establishment 50 may also utilize GPS processing, geo-location processing, barcodes, check-in procedures, and/or any other suitable identification techniques in order for the e-commerce system 30 to ascertain the location of the user. In another example, the user may check-in at a certain central location (e.g., at a front desk) to obtain a table and/or other location for receipt of the purchased goods and/or services.

After detecting the location of the user, the e-commerce system 30 at block 380 may request delivery of the ordered items to the detected location. In particular, the e-commerce system 30 may provide the computing device 51 of the establishment with the detected location of the user and request via the computing device 51 that the order be delivered to the requested location.

At block 390, the establishment 50 may verify the order and deliver the ordered items to the identified location. For instance, in one example, the user may provide a digital receipt and/or other identification to an employee of the establishment 50 as proof that the user purchased the items.

The above-described systems and methods provide the user with the ability to potentially skip lines and process their order and/or pick-up in a more efficient manner. By providing a location status to the establishment 50 offering the items, the establishment 50 may potentially reward loyal customers with loyalty rewards, etc. By understanding the user location and by providing a mechanism to potentially skip lines, the establishment 50 may also offer significant benchmark rewards, such as for example, time limits such as “ready-in-five” to further entice individual users to utilize the described systems and methods.

In one example environment, the disclosed systems and methods may be implemented on a mobile computing device such as an Android-based system due in part to Android's support of NFC. The processing on the backend may be any suitable computing system, including a WSO₂ platform. As noted, NFC and QR Codes may be utilized, and payments may be processed through any suitable electronic payment system including PayPal, Stored Credit Card, Using Enterprise ID and deduction from Pay Stub. The vendor-facing application may include order notification, customer location notification, menu update, status push, customer analytics, etc. The customer-facing application and/or website may include ordering capability, location sharing, order status, menu updates, specials, deals, nutritional information and monitoring, etc.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a tangible, computer readable storage medium such as, for example, flash memory devices, hard disk devices, compact disc media, DVD media, EEPROMs, etc. Such instructions, when executed by one or more computing devices, may enable result in the one or more computing devices promoting the sale of products and/or one or more of the other aspects of the e-commerce environment 10 described above.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment or embodiments disclosed, but that the present invention encompasses all embodiments falling within the scope of the appended claims.

What is claimed is:

1. A method, comprising:
receiving, from a mobile computing device, an order for at least one item;
after said receiving the order, receiving one or more signals from the mobile computing device that are representative of a code read by the mobile computing device, wherein the code identifies a delivery location from a plurality of delivery locations for an establishment;
detecting the delivery location from the plurality of delivery locations based upon the received one or more signals that are representative of the code read by the mobile computing device; and
requesting delivery of the at least one item to the detected delivery location.

2. The method of claim 1, wherein said detecting comprises detecting the delivery location from the plurality of delivery locations based further upon a predetermined location associated with the read code.

3. The method of claim 1, wherein:
the one or more signals are representative of a barcode read by the mobile computing device; and
said detecting comprises detecting the delivery location from the plurality of delivery locations based further upon a predetermined location associated with the read barcode.

4. The method of claim 1, wherein:
the one or more signals are representative of a Quick Response (QR) code read by the mobile computing device; and
said detecting comprises detecting the delivery location from the plurality of delivery locations based further upon a predetermined location associated with the read QR code.

5. The method of claim 1, wherein:
the one or more signals are representative of a near field communication (NFC) identifier read by the mobile computing device; and
said detecting comprises detecting the delivery location from the plurality of delivery locations based further upon a predetermined location associated with the read NFC identifier.

6. The method of claim 1, wherein:
said receiving an order comprises receiving one or more signals from the mobile computing device that are representative of an item code read by the mobile computing device; and
the method further comprises determining an ordered item based upon the one or more signals representative of the read item code received from the mobile computing device.

7. A non-transitory, computer-readable medium, comprising a plurality of instructions that, in response to being executed by a mobile computing device, cause the mobile computing device to:
send an order of one or more items to a computing device associated with an establishment;
after sending the order, read a code indicative of a delivery location from a plurality of delivery locations for the establishment; and
send an indication of the delivery location to the computing device to request delivery of the one or more items to the delivery location.

8. The non-transitory, computer-readable medium of claim 7, wherein the code is a barcode associated with a predetermined delivery location from the plurality of delivery locations.

9. The non-transitory, computer-readable medium of claim 7, wherein the code is a Quick Response (QR) code associated with a predetermined delivery location from the plurality of delivery locations.

10. The non-transitory, computer-readable medium of claim 7, wherein the code is a near field communication (NFC) identifier associated with a predetermined delivery location from the plurality of delivery locations.

11. The non-transitory, computer-readable medium of claim 7, wherein the plurality of instructions further cause the mobile computing device to:
present a list of items available for purchase from the establishment; and
receive a selection of one or more of the listed items to define the order.

12. The non-transitory, computer-readable medium of claim 7, wherein the plurality of instructions further cause the mobile computing device to permit reading one or more item codes that identify items for the order.

13. The non-transitory, computer-readable medium of claim 7, wherein the plurality of instructions further cause the mobile computing device to permit reading an establishment code that identifies the establishment.

14. An ordering system, comprising
a plurality of delivery location codes positioned at plurality of predetermined delivery locations;
a computing device configured to process one or more received orders; and
a mobile computing device application provided by an establishment and configured to generate an order comprising at least one item of the establishment, transmit the order to the computing device, and after transmitting the order, read a delivery location code of the plurality of delivery location codes;
wherein the computing system is further configured to receive the order from the mobile computing device application, detect a delivery location from the plurality of delivery locations based on the delivery location code read by the mobile computing device application, and request delivery of the at least one item of the received order to the detected delivery location.

15. The ordering system of claim 14, wherein the plurality of delivery location codes include one or more barcodes.

16. The ordering system of claim 14, wherein the plurality of delivery location codes include one or more Quick Response (QR) codes.

17. The ordering system of claim 14, further comprising at least one near field communication (NFC) device positioned at a predetermined delivery location of the plurality of predetermined delivery locations, wherein the plurality of delivery location codes include at least one NFC identifier provided by the at least one NFC device.

18. The ordering system of claim 14, further comprising:
a listing of items and associated item codes;
wherein the mobile computing device application is further configured to add an item to the order in response to reading, from the listing of items, an item code associated with the item.

19. The ordering system of claim 14, further comprising:
an establishment code for the establishment;
wherein the mobile computing device application is further configured to identify the establishment and items associated with the establishment in response to reading the establishment code for the establishment.
